(19) United States
(12) Patent Application Publication
(10) Pub. No.: US 2008/0283048 A1
(43) Pub. Date: Nov. 20, 2008

(54) TWO-STAGE REDUCTION OF AEROSOL DROPLET SIZE

(76) Inventor: Johan Petersen, Streamwood, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/749,470

(22) Filed: May 16, 2007

(51) Int. Cl. B05B 1/02

(52) U.S. Cl. 128/200.14; 239/102.2

(57) ABSTRACT

A droplet-size reduction system is described. The system in a first embodiment has a catheter having a distal end and a proximal end and a plurality of lumens therein, a chamber at the proximal end of the catheter, the chamber having a first end and a second end and a fluid pathway therebetween, the first end of the chamber being in fluid communication with the plurality of lumens, an aerosol generator between a first one of the plurality of lumens and the first end of the chamber; and a piezoelectric element disposed in the pathway and coupled to an oscillating voltage supply. In another embodiment, the system has a chamber having a first end and a second end and a fluid pathway therebetween, a plurality of catheters in fluid communication with the first end, an aerosol generator between a first one of the plurality of catheters and the first end, and a piezoelectric element disposed in the pathway and coupled to an oscillating voltage supply. In yet another embodiment, the invention is a method of reducing droplet size in a nebulized medicament, by aerosolizing a liquid medicament to create droplets of the medicament, passing the droplets across a piezoelectric element; and delivering the droplets from the piezoelectric element to a patient.

### BACKGROUND OF THE INVENTION

This invention relates to the art of delivering medicaments to the body of an animal. More particularly, the invention relates to delivering medicaments such as chemotherapy agents to the body of an animal, particularly a human.

Various medicaments must be delivered internally to a patient by means other than oral. Some therapeutic agents are delivered in an aerosol or nebula form into the lungs, either directly by use of a bronchoscopic catheter or by delivery to a mask placed on the patient's face for infusion during respiration. Some therapeutic agents are delivered in a nebulized form directly to internal body organs, such as by use of an insufflator. An insufflator pumps a substantially inert gas, such as carbon dioxide, into the peritoneal cavity to distend the abdomen. A nebulizing catheter then supplies the therapeutic agent directly to the surfaces of the internal body organs. This process is described in United States Published Patent Application No. 2005/0137529 A1, System and Method for Delivering a Substance to a Body Cavity, the disclosure of which is incorporated herein by reference.

In these situations, it is desirable to minimize the size of the droplets of the therapeutic agent. In the case of delivery of a therapeutic agent to the lungs, for example, if the droplet size is too large, the agent will not reach the alveoli of the lungs. Similarly, a finer mist is desirable for delivery to surfaces of the insufflated peritoneal cavity.

The prior art has attempted to reduce droplet size by use of an ultrasonic nebulizer, such as is described in U.S. Pat. No. 7,129,619, Ultrasonic Nebulizer for Producing High-Volume Sub-Micron Droplets, the disclosure of which is incorporated herein by reference. A need still exists for an apparatus and method to reduce droplet size in an aerosol or nebulized mist. The present invention meets this need.

### BRIEF SUMMARY OF THE PREFERRED EMBODIMENTS OF THE INVENTION

The present invention comprises a system and a method for reducing droplet size. The system in a first embodiment has a catheter having a distal end and a proximal end and a plurality of lumens therein, a chamber at the proximal end of the catheter, the chamber having a first end and a second end and a fluid pathway therebetween, the first end of the chamber being in fluid communication with the plurality of lumens, an aerosol generator between a first one of the plurality of lumens and the first end of the chamber; and a piezoelectric element disposed in the pathway and coupled to an oscillating voltage supply. In another embodiment, the system has a chamber having a first end and a second end and a fluid pathway therebetween, a plurality of catheters in fluid communication with the first end, a nozzle between a first one of the plurality of catheters and the first end, and a piezoelectric element disposed in the pathway and coupled to an oscillating voltage supply. In yet another embodiment, the invention is a method of reducing droplet size in a nebulized medicament, by forcing a liquid medicament through an aerosol generator to create droplets of the medicament, passing the droplets across a piezoelectric element; and delivering the droplets from the piezoelectric element to a patient.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying nonscale drawings, wherein like reference numerals identify like elements in which:

FIG. 1 is a partially cutaway diagram of the apparatus of the preferred embodiment of the present invention.

FIG. 2 is a diagram of a portion of the delivery catheter of the apparatus of FIG. 1.

FIG. 3 is a partially cutaway diagram of the apparatus of another embodiment of the present invention.

FIG. 4 is a block diagram of the method of the preferred embodiment of the present invention.

FIG. 5 is a diagram of a portion of another embodiment of the present invention.

### DETAILED DESCRIPTION OF THE PREFERRED EMBODIMENTS OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein. The embodiments described herein apply to use on a human, but can be used on any animal. The embodiments described will be for use of liquid medicaments, such as liquid pharmaceutical products or liquid pharmaceutical products with particular or colloidal suspensions. The apparatus and methods claimed, however, are for any situation in which smaller droplet size is desirable.

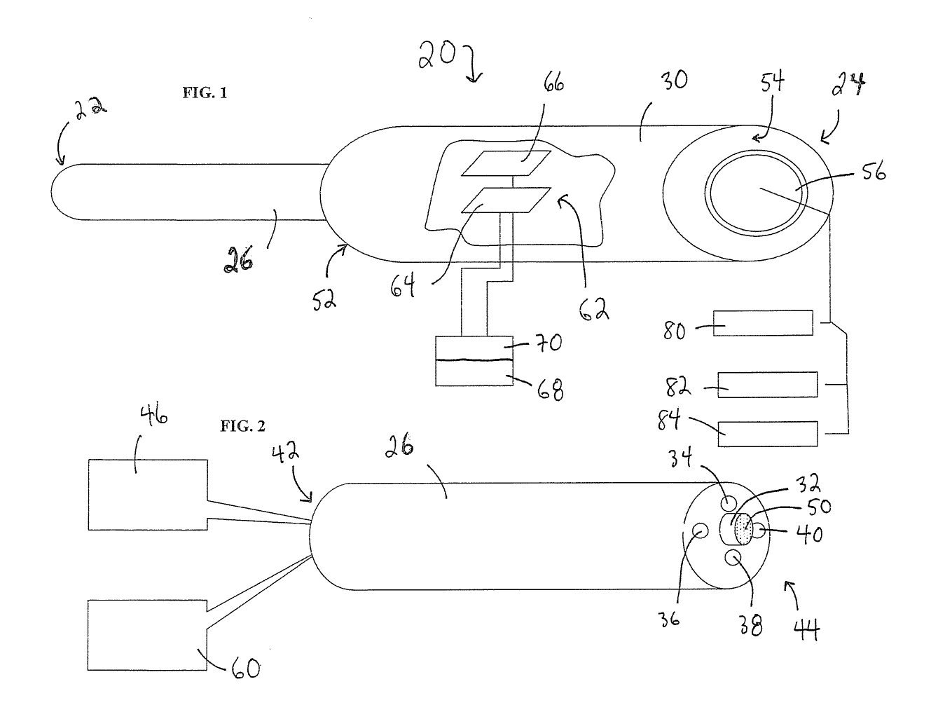

In a first embodiment, the present invention is a particle-size reduction system 20 as shown in FIG. 1. System 20 has a distal end 22 and a proximal end 24. System 20 comprises a catheter 26 at distal end 22 and an ultrasonic nebulizer chamber 30 located at proximal end 24.

Catheter 26, a portion of which is shown in FIG. 2, is a tube having a plurality of lumens therein, each lumen 32, 34, 36, 38, 40 forming a fluid pathway from upstream end 42 of catheter 26 to downstream end 44 of catheter 26. Catheter 26 is a conventional multi-lumen catheter and is made of a medical-grade material, such as silicone or polyethylene.

Central lumen 32 is coupled to and in fluid communication at upstream end 42 with a supply of liquid medicament 46. Liquid medicament can be supplied by a pump, by gravity, or by a syringe. Lumen 32 terminates at downstream end 44 with aerosol generator 50. Aerosol generator 50 is a device to create an aerosol suspension of liquid medicament 46 in a gas stream. Aerosol generator 50 is preferably a conventional spray nozzle.

Aerosol generator 50 is coupled to and in fluid communication with an upstream end 52 of chamber 30. Although there is preferably a single lumen 32 for carrying liquid medicament 46, in other embodiments a plurality of lumens can be used for this purpose.

In the preferred embodiment, lumens 34, 36, 38, 40 are coupled to and in fluid communication at upstream end 42 with a supply of gas 60. Gas 60 can be from a bottled gas supply, a plant pressurized gas system, or a pump. Lumens 34, 36, 38, 40 are coupled to and in fluid communication at downstream end 44 with upstream end 52 of chamber 30. Although there are preferably four lumens 34, 36, 38, 40 carrying gas 60, arranged concentrically around lumen 32, in other embodiments other numbers of lumens, from zero on up, can be used, and other orientations of lumens can be used.

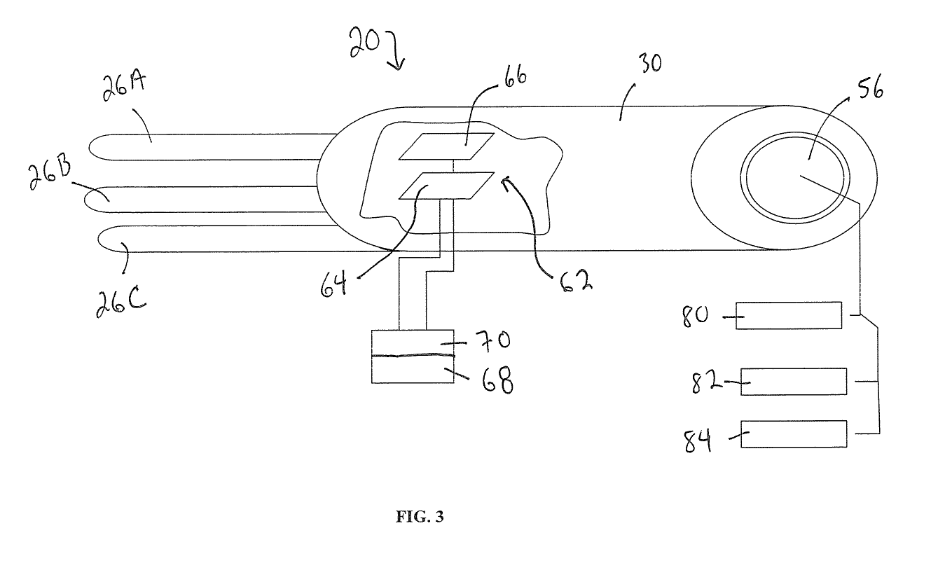

Please note that, in the preferred embodiment, medicament 46 and gas 60 are carried within lumens 32, 34, 36, 38, 40 of a single catheter 26. In other embodiments, separate catheters are used to deliver medicament 46 and gas 60 to upstream end 52 of chamber 30. For example, in FIG. 3, separate catheter 26A delivers liquid medicament 46, catheter 26B delivers gas 60, and catheter 26C delivers a second liquid, such as irrigation liquid.

Chamber 30 is a hollow cylindrical member having a fluid pathway from upstream end 52 to downstream end 54. An orifice 56 at downstream end 54 terminates proximal end 24 of catheter 26.

Chamber 30 holds a piezoelectric element 62. Preferably, piezoelectric element 62 is a pair of piezoelectric plates 64, 66 disposed within the fluid pathway of chamber 30. Each plate 64, 66 is electronically coupled to a power supply 68 and circuitry 70 that create a voltage having an oscillation frequency. Piezoelectric element 62 is preferably made of lead zirconium titanate, a ceramic made from a combination of powders of PbO₂, ZrO₂, and TiO₂, but in other embodiments is made of a different material exhibiting piezoelectric properties. Piezoelectric element 62 is preferably made of a pair of plates 64, 66 as illustrated. In other embodiments, piezoelectric element 62 is an annular ring, a plate, or another structure.

It is known in the art that application of an oscillating voltage to a piezoelectric crystal causes mechanical stress within the crystal, and that this stress causes nebulization of a liquid contacting the crystal. Accordingly, an oscillating voltage is applied to plates 64, 66, preferably as described in U.S. Pat. No. 7,129,619, Ultrasonic Nebulizer for Producing High-Volume Sub-Microin Droplets, the disclosure of which is incorporated herein, to further nebulize the droplets of medicament 46

In one embodiment, a face mask 80 couples to proximal end 24 of catheter 26. In another embodiment, a trocar 82 is coupled to proximal end 24 of catheter 26. Trocar 72 is configured, to enter a patient, preferably through an insufflated peritoneal cavity. In yet another embodiment, an endoscope 84 is coupled to proximal end 24 of catheter 26. Endoscope 84 can be any device used for imaging, biopsy, or surgery of the internal organs, including by way of example and not by way of limitation, bronchoscopy or colonoscopy. Catheter 26 in each of these embodiments is therefore in fluid communication with mask 80, trocar 82, or endoscope 84. Although FIGS. 1 and 3, for ease of illustration, show catheter 26 coupled to all three of mask 80, trocar 82, and endoscope 84, in normal use only one would be used. There is no impediment, for the standpoint of the present invention, however, to coupling catheter 26 to more than one of mask 80, trocar 82, and endoscope 84.

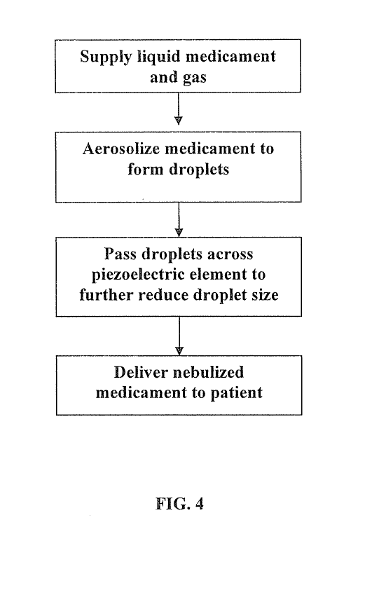

The use of system 20 is shown in flow chart form in FIG. 4. A supply of liquid medicament 46 and a supply of gas 60 are coupled to distal end 22 of catheter 26 (step 101). Medicament 46 is preferably a chemotherapeutic agent, but can be a pain-relief agent, an antibiotic, a tissue adhesion agent, or any other therapeutic agent that is desired to be delivered in a nebulized form, such as to the lungs of a patient or to an insufflated peritoneal cavity of a patient.

Gas 60 in a first embodiment is air, for delivery of medicament 46 to the lungs of the patient. In another embodiment, gas 60 can be oxygen-enriched air or can be substantially pure oxygen. In yet another embodiment, gas 60 is a substantially inert gas such as carbon dioxide, for delivery of medicament 46 to an insufflated peritoneal cavity. In yet another embodiment, gas 60 is an inert gas such as argon or helium for delivery of medicament 46 to an insufflated peritoneal cavity. In other embodiments, mixtures of gases are used, such as a mixture of oxygen and helium.

Gas 60 and medicament 46 are delivered through catheter 26 in a conventional manner, such as by pressure differential, pumping, or gravity feed. In a first embodiment, using the system of FIG. 1, medicament 46 is delivered under pressure to lumen 32 and pressurized gas 60 is delivered to lumens 34, 36, 38, 40 (step 101). Medicament 46 is aerosolized by aerosol generator 50 and is converted to an aerosol, or droplets of medicament 46, within the fluid pathway of chamber 30 (step 103). Gas 60 enters upstream end 52 of chamber 30 from lumens 34, 36, 38, 40. The aerosolized droplets of medicament 46 are carried by the gas stream from lumens 34, 36, 38, 40 through the fluid pathway of chamber 30. As the aerosolized medicament 46 passes across and contacts plates 66, 66, the oscillating voltage applied to plates 64, 66 further nebulizes medicament 46, further reducing the size of the droplets of medicament 46 (step 105). The stream of gas 60 carries the droplets of medicament 46 further along the fluid pathway of chamber 30 to downstream end 54 and out through orifice 56.

Medicament 46 is then delivered to the patient (step 107), either to the lungs via mask 80, to internal body organs within a body cavity, such as the peritoneal cavity, via trocar 82, or to an internal body organ via endoscope 84, such as delivery to the lungs via a bronchoscope. For example, catheter 26 can be inserted through the instrument channel of a conventional bronchoscope for delivery of medicament 46 to the lungs during a bronchoscopic examination.

In another embodiment, one or more of lumens 34, 36, 38, 40 are coupled to a supply of a second liquid, such as water or a liquid medicament. In this embodiment, while liquid medicament 46 is conveyed through lumen 32, the second liquid can be conveyed through a second lumen, such as lumen 34, to provide a low-quantity irrigation to the patient's body cavity. (In the embodiment illustrated in FIG. 3, the second liquid can be conveyed through catheter 26C.) In this embodiment, the user would likely switch off the voltage to piezoelectric element 62, using circuitry 70, while irrigating the patient's body cavity with the second liquid through lumen 34 (or catheter 26C). Gas 60 is preferably still in fluid communication with lumens 36, 38, 40 (or catheter 26B). After irrigation, the user can shut off the supply of the second liquid to lumen 34 (or catheter 26C) and switch back to supplying gas 60 through lumens 36, 38, 40 (or catheter 26B).

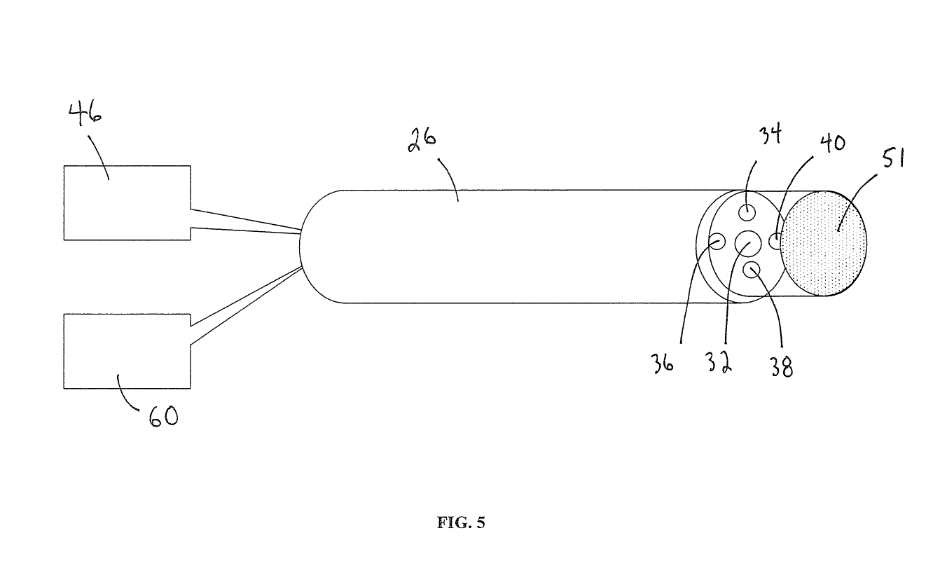

In yet another embodiment, as shown in FIG. 5, lumens 32, 34, 36, 38, and 50 all terminate in aerosol generator 51. Accordingly, instead of only liquid medicament 46 going through aerosol generator 50, as in FIG. 1, both liquid medicament 46 and gas 60 go through aerosol generator 51. (If a second liquid for irrigation is conveyed through, for example, lumen 34, that lumen would preferably by pass aerosol generator 51.) Otherwise, this embodiment is identical to the embodiment illustrated in FIG. 1. Alternatively, catheters 26A and 26B of FIG. 3 can both terminate at aerosol generator 51. (Catheter 26C, with a second liquid for irrigation, would preferably bypass aerosol generator 51.)

By the two-stage reduction of droplet size described herein, the amount of medicament 46 reaching the alveoli of the lungs is increased. Furthermore, the efficiency of delivering medicament 46 to an insufflated peritoneal cavity is increased.

While preferred embodiments of the present invention are shown and described, it is envisioned that those skilled in the art may devise various modifications of the present invention without departing from the spirit and scope of the appended claims.

I claim:

1. A droplet size reduction system, comprising:
a catheter having a distal end and a proximal end and a plurality of lumens therein;
a chamber at said proximal end of said catheter, said chamber having a first end and a second end and a fluid pathway therebetween, said first end of said chamber being in fluid communication with said plurality of lumens;
an aerosol generator between a first one of said plurality of lumens and said first end of said chamber; and
a piezoelectric element disposed in said fluid pathway and coupled to an oscillating voltage supply.

2. The system of claim 1, wherein said second end of said chamber is coupled to at least one of a mask, a trocar, and an endoscope.

3. The system of claim 1, further comprising a supply of a liquid medicament in fluid communication with said first one of said plurality of lumens.

4. The system of claim 3, further comprising a supply of a gas in fluid communication with a second one of said plurality of lumens.

5. The system of claim 4, further comprising a supply of a liquid in fluid communication with a third one of said plurality of lumens.

6. The system of claim 3, further comprising a supply of a liquid in fluid communication with a second one of said plurality of lumens.

7. The system of claim 1, wherein said aerosol generator is between a second one of said plurality of lumens and said first end of said chamber.

8. A droplet-size reduction system, comprising:
a chamber having a first end and a second end and a fluid pathway therebetween
a plurality of catheters in fluid communication with said first end;
an aerosol generator between a first one of said plurality of catheters and said first end; and
a piezoelectric element disposed in said pathway and coupled to an oscillating voltage supply.

9. The system of claim 8, wherein said chamber is coupled to at least one of a mask, a cannula, a trocar, and an endoscope.

10. The system of claim 8, further comprising a supply of a liquid medicament in fluid communication with said first one of said plurality of catheters.

11. The system of claim 10, further comprising a supply of a gas in fluid communication with a second one of said plurality of catheters.

12. The system of claim 11, further comprising a supply of a liquid in fluid communication with a third one of said plurality of catheters.

13. The system of claim 10, further comprising a supply of a liquid in fluid communication with a second one of said plurality of catheters.

14. The system of claim 8, wherein said aerosol generator is between a second one of said plurality of lumens and said first end of said chamber.

15. A method of reducing droplet size in a nebulized medicament, comprising:
aerosolizing a liquid medicament to create droplets of said medicament;
passing said droplets across a piezoelectric element; and
delivering said droplets from said piezoelectric element to a patient.

16. The method of claim 15, wherein said delivering step comprises using at least one of a mask, a trocar, and an endoscope.
